(19) United States
(12) Patent Application Publication
(10) Pub. No.: US 2005/0250010 A1
(43) Pub. Date: Nov. 10, 2005

(54) Coating liquid for electrode formation, electrode. electrochemical device, and process for producing these

(75) Inventors: Masato Kurihara, Chuo-ku (JP); Tadashi Suzuki, Chuo-ku (JP); Atsushi Sano, Chuo-ku (JP); Satoshi Maruyama, Chuo-ku (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 10/537,498

(22) PCT Filed: Dec. 5, 2003
(86) PCT No.: PCT/JP03/15622

§ 371 Date: Jul. 12, 2005

(30) Foreign Application Priority Data
Dec. 5, 2002 (JP) 2002-354115

(51) Int. Cl. H01M 4/62; B05D 5/12; B05D 1/36

(52) U.S. Cl. 429/217; 252/182.1; 429/232; 427/58; 427/202

(57) ABSTRACT

The coating liquid for forming an electrode in accordance with the present invention includes, as constituents, a granulated particle containing an electrode active material, a conductive auxiliary agent having an electronic conductivity, and a binder capable of binding the electrode active material and conductive auxiliary agent to each other; and a liquid adapted to disperse or dissolve the granulated particle, whereas the granulated particle is formed by way of a granulating step of preparing a material liquid containing the binder, the conductive auxiliary agent, and a solvent, and then attaching the material liquid to a surface of a particle made of the electrode active material and bringing a particle made of the binder and a particle made of the conductive auxiliary agent into close contact with the surface. An electrode is formed by using the coating liquid for forming an electrode, whereas an electrochemical device is equipped with the electrode.

### TECHNICAL FIELD

The present invention relates to a coating liquid for forming an electrode, and an electrode and an electrochemical device such as battery, electrolytic cell or capacitor equipped with the electrode formed by using the coating liquid. Also, the present invention relates to a method of manufacturing the coating liquid for forming an electrode, a method of manufacturing the electrode, and a method of manufacturing the electrochemical device.

### BACKGROUND ART

Portable devices have remarkably been developing in recent years, a major driving force for which is the evolution of high-energy batteries such as lithium-ion secondary batteries which are widely employed as their power supplies.

A lithium-ion secondary battery is mainly constituted by a cathode, an anode, and an electrolyte layer (e.g., a layer made of a liquid electrolyte or solid electrolyte) disposed between the cathode and anode. The cathode and/or anode have conventionally been manufactured by way of the steps of preparing their respective electrode-forming coating liquids (e.g., in a slurry or paste form) containing the electrode active materials, a binder, and a conductive auxiliary agent each of which is dispersed therein; applying the coating liquids to surfaces of collector members (e.g., metal foils); and then drying the coating liquids, so as to form layers including the electrode active materials on the surfaces of the collector members. In this method (wet method), there are cases where no conductive auxiliary agents are added to the coating liquid. Also, there is a case where a conductive polymer is further added to the coating liquid, so as to form a so-called “polymer electrode”. When the electrolyte layer is solid, there is a case employing a method of forming an electrode by applying the coating liquid to a surface of the electrolyte layer.

In lithium-ion secondary batteries, various studies have been under way in order to achieve further improvements in battery characteristics (e.g., higher capacity, improved safety, and enhanced energy density) in response to developments in portable devices from now on. In particular, in lithium-ion secondary batteries, attempts have been made in order to realize a configuration of so-called “all-solid-state battery” employing an electrolyte layer made of a solid electrolyte from the viewpoints of reducing the weight of the battery and improving its energy density and safety.

A battery having the above-mentioned configuration of “all-solid-state battery” exhibits the following advantages (I) to (IV):
(I) The battery having the configuration of “all-solid-state battery” is free of leakage, can attain an excellent heat resistance (high-temperature stability), and can sufficiently prevent electrolyte components and electrode active materials from reacting with each other, since its electrolyte layer is not made of a liquid electrolyte but a solid electrolyte. Therefore, excellent safety and reliability can be obtained.
(II) The battery having the configuration of “all-solid-state battery” can easily use metal lithium as its anode (i.e., construct a so-called “metal lithium secondary battery), which has been difficult with an electrolyte layer made of a liquid electrolyte, and thus can further improve the energy density.
(III) When constructing a module in which a plurality of unit cells are arranged in one case, the battery having the configuration of “all-solid-state battery” makes it possible to connect a plurality of unit cells in series, which has been impossible to realize with an electrolyte layer made of a liquid electrolyte. Therefore, modules having various output voltages, relatively high output voltages in particular, can be constructed.
(IV) As compared with the case equipped with an electrolyte layer made of a liquid electrolyte, the battery having the configuration of “all-solid-state battery” has a higher degree of freedom in terms of employable battery forms, and can easily construct the battery in a compact fashion. Therefore, the battery configuration can easily conform to conditions under which the battery is placed within a device such as a portable device mounting the battery as a power supply (conditions such as the placing position, the size of the placing space, and the form of the placing space).

Known examples of the solid electrolyte having a lithium ion conductivity which is a constituent material of the above-mentioned electrolyte layer include (i) solid polymer electrolytes (so-called genuine polymer electrolytes) or ceramic solid electrolytes (electrolytes made of inorganic materials such as glass materials); (ii) polymer electrolytes (gel electrolytes) made of plasticized (gelled) solid polymer electrolytes; and (iii) polymer electrolytes (gel electrolytes) obtained by mixing liquid electrolytes (e.g., liquids in which electrolyte salts are dissolved in organic solvents), plasticizers (gelling agents), and polymers such as fluorine resin.

Known as all-solid-state batteries having the configuration comprising the electrolyte layer made of the above-mentioned solid electrolytes and the electrodes manufactured by the above-mentioned conventional general manufacturing method (wet method) include a battery equipped with an electrolyte layer made of a gelled solid electrolyte based on polyvinylidene chloride (see, for example, U.S. Pat. No. 5,296,318) and a battery equipped with an electrolyte layer comprising a solid polymer electrolyte containing a copolymer based on polyvinylidene fluoride and/or a copolymer based on vinylidene fluoride (see, for example, Japanese Patent Application Laid-Open No. HEI 10-21963).

### DISCLOSURE OF THE INVENTION

The inventors studied the above-mentioned solid polymer electrolytes or ceramic solid electrolytes and, as a result, have found that all-solid-state batteries using the solid polymer electrolytes or ceramic solid electrolytes enable favorable power generation (charging/discharging) within a range in which the operating temperature is relatively high (i.e., within the range of 60° to 120° C.), but are problematic in that the power generation (charging/discharging) becomes quite difficult within the range of 40° C. or lower, e.g., at room temperature, where the operating temperature is relatively low. Hence, the inventors have found that the all-solid-state batteries are problematic in that, when a device (e.g., portable device) to be used has a relatively low operating temperature region (near 25° C. in particular), it becomes quite difficult for the all-solid-state batteries using the solid polymer electrolytes or ceramic solid electrolytes to be employed as power supplies.

The inventors have further found that the all-solid-state batteries have the following problem. Namely, the above-mentioned problems become more remarkable when the all-solid-state battery configuration is intended, since the ionic conductivity of the electrolyte layer decreases greatly, the interface resistance between the electrolyte layer and electrodes becomes greater, and so forth, as compared with the case using a liquid electrolyte.

Also, in primary and secondary batteries of species different from that of the above-mentioned lithium-ion secondary batteries, those having electrodes made by the above-mentioned conventional general manufacturing method (wet method), i.e., the method using a slurry containing at least the electrode active material, conductive auxiliary agent, and binder each of which is dispersed therein, have problems similar to those mentioned above.

Further, problems similar to those mentioned above exist in electrolytic cells and capacitors (electric double layer capacitors, aluminum electrolytic capacitors, etc.) having electrodes made by a method using an electronically conductive material (carbon material or metal oxide) in place of the electrode active materials in the batteries, and employing a slurry containing at least this material, a conductive auxiliary agent, and a binder each of which is dispersed therein.

It is an object of the present invention to provide a coating liquid for forming an electrode, which can easily and reliably form an electrode which is capable of fully advancing an electrode reaction in a relatively low operating temperature region while having an excellent polarization characteristic, an electrode formed by using the same, and an electrochemical device equipped with this electrode. It is another object of the present invention to provide respective manufacturing methods which can easily and reliably yield the above-mentioned coating liquid for forming an electrode, the electrode, and the electrochemical device.

The inventors conducted diligent studies in order to achieve the above-mentioned objects and, as a result, have found that, when a method similar to that used for conventional batteries is employed for forming an electrode for an all-solid-state battery using a solid polymer electrolyte or ceramic solid electrolyte, the method using a slurry containing at least the electrode active material, conductive auxiliary agent, and binder each of which is dispersed therein is employed at the time of forming the electrode, whereby the state of dispersion of the electrode active material, conductive auxiliary agent, and binder in the active material containing layer of the resulting electrode is nonuniform, which has a great influence on the occurrence of the above-mentioned problems.

In the conventional method using a slurry, the slurry is applied to a surface of a collector member, so as to form a coating made of the slurry on this surface, and the coating is dried, so as to eliminate its solvent, thereby forming an active material containing layer. The inventors have found that the conductive auxiliary agent and binder having a relatively small specific gravity float up to the vicinity of the coating surface in the process of drying the coating, whereby the state of dispersion of the electrode active material, conductive auxiliary agent, and binder in the coating becomes nonuniform, so that the electrode active material, conductive auxiliary agent, and binder fail to attain sufficient adhesion therebetween, and no favorable electron conduction path is constructed in the resulting active material containing layer. The inventors have further found that, since the state of dispersion of the electrode active material, conductive auxiliary agent, and binder becomes nonuniform in this case, the adhesion of the electrode active material and conductive auxiliary agent to the collector is not fully obtained.

The inventors have found it quite effective to form an electrode by using a coating liquid for forming an electrode containing the following granulated particle as a constituent for achieving the above-mentioned objects, thereby accomplishing the present invention.

Namely, in one aspect, the present invention provides a coating liquid for forming an electrode, the coating liquid including, as constituents, a granulated particle containing an electrode active material, a conductive auxiliary agent having an electronic conductivity, and a binder capable of binding the electrode active material and conductive auxiliary agent to each other; and a liquid adapted to disperse or dissolve the granulated particle.

In the present invention, the “electrode active material” to become a constituent material of the granulated particle refers to the following materials depending on the electrode to be formed. Namely, the “electrode active material” refers to a reducer and an oxidizer when the electrode to be formed is an electrode used as an anode and a cathode of a primary battery, respectively.

When the electrode to be formed is an anode (at the time of discharging) used in a secondary battery, the “electrode active material” is a reducer while being a material which can exist chemically stably either in its reduced or oxidized state and capable of reversibly advancing a reducing reaction from the oxidized state to the reduced state and an oxidizing reaction from the reduced state to the oxidized state. When the electrode to be formed is a cathode (at the time of discharging) used in a secondary battery, the “electrode active material” is an oxidizer while being a material which can exist chemically stably either in its reduced or oxidized state and capable of reversibly advancing a reducing reaction from the oxidized state to the reduced state and an oxidizing reaction from the reduced state to the oxidized state.

When the electrode to be formed is one used in primary and secondary batteries, the “electrode active material” may be a material adapted to occlude or release (by intercalation or doping/undoping) a metal ion involved in an electrode reaction in addition to the above-mentioned electrode active materials. Examples of this material include carbon materials used in anodes and/or cathodes of lithium-ion secondary batteries and metal oxides (including mixed metal oxides).

When the electrode to be formed is an electrode used in an electrolytic cell or an electrode used in a capacitor (condenser), the “electrode active material” refers to metals (including metal alloys), metal oxides, and carbon materials having an electronic conductivity.

In the present invention, as mentioned above, a granulated particle in which a conductive auxiliary agent, an electrode active material, and a binder are brought into close contact with each other while in a quite favorable dispersion state is prepared beforehand, and is used as a constituent for the coating liquid for forming an electrode. Therefore, in the process of forming a liquid film made of the coating liquid on a surface of a collector member and then solidifying the liquid film (e.g., the process of drying the liquid film and so forth), the conductive auxiliary agent and binder can fully be prevented from floating up to the vicinity of the surface during when the liquid film solidifies. This can fully prevent the conductive auxiliary agent, electrode active material, and binder from lowering the adhesion therebetween and the conductive auxiliary agent and electrode active material from decreasing their adhesion to the surface of the collector member as in the conventional cases. Hence, the inventors presume that an electron conduction path (electron conduction network) much better than that in conventional electrodes is three-dimensionally constructed within the active material containing layer of the electrode obtained in the present invention.

A quite favorable ion conduction path can easily be constructed within the active material containing layer of the electrode by performing any of the techniques of (A) further adding a conductive polymer having an ionic conductivity as a constituent material when forming a granulated particle, (B) adding a conductive polymer as a constituent other than the granulated particle when preparing the coating liquid for forming an electrode, and (C) adding a conductive polymer as a constituent material of the granulated particle and as a constituent of the coating liquid for forming an electrode. When a conductive polymer having an ionic conductivity can be used as a binder to become a constituent material of the granulated particle, this binder seems to contribute to constructing an ion conduction path within the active material containing layer as well. The conductive polymer may also be an electronically conductive polymer electrolyte.

Namely, the present invention can easily and reliably form an electrode having an electronic conductivity and an ionic conductivity which are better than those of conventional electrodes. In the electrode formed by using the coating liquid for forming an electrode in accordance with the present invention, contact interfaces between the conductive auxiliary agent, electrode active material, and electrolyte (solid electrolyte or liquid electrolyte), which become reaction sites for electron transfer reactions proceeding within the active material containing layer, are three-dimensionally formed with a sufficient size, while the active material containing layer and collector member are in a quite favorable electric contact state.

As a result, using such an electrode can easily and reliably construct an all-solid-state battery such as a metal lithium secondary battery which can favorably operate at room temperature (e.g., 25° C.) not higher than 40° C., for example. Since a granulated particle in which each of the conductive auxiliary agent, electrode active material, and binder is in a quite favorable dispersion state is prepared beforehand, the present invention can make the amounts of addition of the conductive auxiliary agent and binder much smaller than those conventionally employed.

In the coating liquid for forming an electrode in accordance with the present invention, the granulated particle may further contain a conductive polymer. Using the coating liquid including the granulated particle can form an electrode which functions as the above-mentioned polymer electrode.

The coating liquid for forming an electrode in accordance with the present invention may further contain a conductive polymer or a monomer to become a constituent material of the conductive polymer. Using this coating liquid for forming an electrode also can form an electrode which functions as the above-mentioned polymer electrode. Preferably, from the viewpoint of enhancing the dispersibility of the conductive polymer or the monomer to become a constituent material of the conductive polymer, the liquid adapted to disperse or dissolve the granulated particle is capable of dissolving the conductive polymer or a monomer to become a constituent material of the conductive polymer, whereas the coating liquid for forming an electrode is prepared by dissolving the conductive polymer in the liquid and then adding the granulated particle into thus obtained solution.

In the present invention, the conductive polymer to become a constituent of the coating liquid for forming an electrode may be of a kind identical to or different from that of the conductive polymer to become a constituent of the granulated particle. When the coating liquid for forming an electrode contains a “monomer to become a constituent material of the conductive polymer”, the conductive polymer is generated by advancing a polymerization reaction when forming the active material containing layer of the electrode while using the coating liquid. Means for advancing the polymerization reaction is not limited in particular as long as it can advance the polymerization reaction of the monomer. For example, depending on the kind of the monomer in use, additives such as catalysts and polymerization initiators may be added, and heat treatment or irradiation with light such as UV rays may be carried out.

In the present invention, as mentioned above, the electrode active material may be an active material usable in a cathode of a primary or secondary battery. In the present invention, the electrode active material may be an active material usable in an anode of a primary or secondary battery as well. In the present invention, the electrode active material may be a carbon material or metal oxide having an electronic conductivity usable in an electrode constituting an electrolytic cell or capacitor.

In the present invention, the electrolytic cell or capacitor refers to an electrochemical cell comprising at least an anode, a cathode, and an ionically conductive electrolyte layer, in which the anode and cathode are arranged so as to oppose each other by way of the electrolyte layer. In the present invention, “capacitor” is synonymous with “condenser”.

In another aspect, the present invention provides an electrode comprising, at least, a conductive active material containing layer including, as a constituent material, a granulated particle containing an electrode active material, a conductive auxiliary agent having an electronic conductivity, and a binder capable of binding the electrode active material and conductive auxiliary agent to each other; and a conductive collector member disposed in electric contact with the active material containing layer.

Since the active material containing layer includes the above-mentioned granulated particle, the electrode can fully advance an electrode reaction even in a relatively low operating temperature region of 40° C. or lower such as room temperature, thus yielding an excellent polarization characteristic. The active material containing layer may further contain a conductive polymer, whereas the granulated particle may further contain a conductive polymer. In this case, the electrode can function as a polymer electrode.

In still another aspect, the present invention provides an electrochemical device comprising, at least, an anode, a cathode, and an ionically conductive electrolyte layer, the anode and cathode being arranged so as to oppose each other by way of the electrolyte layer; wherein at least one of the anode and cathode comprises, at least, a conductive active material containing layer including, as a constituent material, a granulated particle containing an electrode active material, a conductive auxiliary agent having an electronic conductivity, and a binder capable of binding the electrode active material and conductive auxiliary agent to each other; and a conductive collector member disposed in electric contact with the active material containing layer.

This electrochemical device comprises an electrode including a granulated particle as at least one of, preferably each of, the anode and cathode, and thus can also fully operate in a relatively low operating temperature region of 40° C. or lower such as room temperature.

In the present invention, the “electrochemical device” refers to a device comprising, at least, an anode, a cathode, and an ionically conductive electrolyte layer, whereas the anode and cathode are disposed so as to oppose each other by way of the electrolyte layer. In the present invention, the electrochemical device may be configured as a module comprising a plurality of unit cells arranged in series or in parallel within a case.

In the electrode, the active material containing layer may further contain a conductive polymer, whereas the granulated particle may further contain a conductive polymer. In this case, the electrode can function as a polymer electrode in the electrochemical device of the present invention.

In the present invention, the electrolyte layer may contain a solid electrolyte. In this case, the solid electrolyte may contain a ceramic solid electrolyte or a solid polymer electrolyte.

In still another aspect, the present invention provides a method of manufacturing a coating liquid for forming an electrode, the method comprising the steps of coating and integrating a particle made of an electrode active material with a conductive auxiliary agent and a binder, so as to yield a granulated particle; and adding the granulated particle to a liquid adapted to disperse or dissolve the granulated particle.

This manufacturing method can easily and reliably form a granulated particle having the above-mentioned structure by way of the above-mentioned step of yielding the granulated particle (hereinafter referred to as “granulating step” when necessary). The above-mentioned manufacturing method can easily and reliably yield the above-mentioned coating liquid for forming an electrode in accordance with the present invention. Therefore, using the coating liquid obtained by this manufacturing method can more easily and reliably form an electrode having excellent electronic and ionic conductivities and such an excellent polarization characteristic as to be able to advance an electrode reaction fully in a relatively low operating temperature region of 40° C. or lower such as room temperature.

In the granulating step in the method of manufacturing a coating liquid for forming an electrode in accordance with the present invention, the above-mentioned “coating and integrating a particle made of an electrode active material with a conductive auxiliary agent and a binder” refers to attaining a state in which respective particles made of the conductive auxiliary agent and binder are brought into contact with at least a part of the particle made of an electrode active material. Namely, it will be sufficient if the surface of the particle made of an electrode active material is partly covered with the respective particles made of the conductive auxiliary agent and binder, and it is not necessary for the whole surface to be covered. The “particle made of an electrode active material” may include a material other than the electrode active material to such an extent that functions of the present invention (functions of the electrode active material) are not lost.

Preferably, from the viewpoint of more easily and reliably forming the granulated particle having the above-mentioned structure, the step of yielding the granulated particle (granulating step) in the method of manufacturing a coating liquid for forming an electrode includes the steps of preparing a material liquid containing the binder, the conductive auxiliary agent, and a solvent; and attaching the material liquid to the particle made of the electrode active material, and drying the liquid so as to remove the solvent from the material liquid attached to a surface of the particle made of the electrode active material and bring the particle made of the electrode active material and the particle made of the conductive auxiliary agent into close contact with each other by way of the binder.

Preferably, in the step of yielding the granulated particle (granulating step) in the method of manufacturing a coating liquid for forming an electrode in accordance with the present invention, the material liquid is attached by spraying to the particle made of the electrode active material. This can further enhance the dispersibility of the binder, conductive auxiliary agent, and electrode active material in the resulting granulated particle.

Preferably, in the granulating step in the method of manufacturing a coating liquid for forming an electrode, the solvent contained in the material liquid is adapted to dissolve the binder and disperse the conductive auxiliary agent. This can also enhance the dispersibility of the binder, conductive auxiliary agent, and electrode active material in the resulting granulated particle.

In the granulating step in the method of manufacturing a coating liquid for forming an electrode, a conductive polymer may further be dissolved in the material liquid. As a consequence, the resulting granulated particle further contains the conductive polymer. Using this granulated particle can form an electrode functioning as the above-mentioned polymer electrode.

In the method of manufacturing a coating liquid for forming an electrode, a conductive polymer or a monomer to become a constituent material of the conductive polymer may further be dissolved in the liquid adapted to disperse or dissolve the granulated particle. Using this coating liquid for forming an electrode can also form an electrode functioning as the above-mentioned polymer electrode. Preferably, from the viewpoint of enhancing the dispersibility of the conductive polymer or a monomer to become a constituent material of the conductive polymer, the liquid adapted to disperse or dissolve the granulated particle is capable of dissolving the conductive polymer or the monomer to become a constituent material of the conductive polymer, whereas the coating liquid for forming an electrode is prepared by dissolving the conductive polymer in the liquid and then adding the granulated particle into thus obtained solution.

In still another aspect, the present invention provides a method of manufacturing an electrode comprising, at least, a conductive active material containing layer including an electrode active material, and a conductive collector member disposed in electric contact with the active material containing layer, the method comprising the steps of applying the coating liquid for forming an electrode manufactured by the above-mentioned method of manufacturing a coating liquid for forming an electrode to a part to be formed with the active material containing layer in the collector member; and solidifying a liquid film made of the coating liquid applied to the part to be formed with the active material containing layer in the collector member.

Using the coating liquid for forming an electrode obtained by the above-mentioned method of manufacturing a coating liquid for forming an electrode in accordance with the present invention can easily and reliably yield the above-mentioned electrode of the present invention, i.e., an electrode having excellent electronic and ionic conductivities and such an excellent polarization characteristic as to be able to advance an electrode reaction fully in a relatively low operating temperature region (e.g., room temperature of 40° C. or lower).

In the method of manufacturing an electrode in accordance with the present invention, the coating liquid for forming an electrode may contain a monomer to become a constituent material of a conductive polymer, and a polymerization reaction of the monomer may be advanced in the step of solidifying the liquid film, so as to generate the conductive polymer.

This manufacturing method forms a liquid film on the collector member and then generates a conductive polymer by polymerizing the monomer in the liquid film, thereby making it possible to produce the conductive polymer in gaps between granulated particles while substantially keeping a favorable dispersion state of granulated particles in the liquid film. Therefore, as compared with a method in which a conductive polymer (a particle made of a conductive polymer) is contained beforehand in a coating liquid for forming an electrode, a liquid film is formed on a collector member, and then the liquid film is solidified, the dispersion state of the granulated particle and conductor polymer can be made more favorable in the resulting active material containing layer.

Namely, ion conduction networks and electron conduction networks in which finer and denser particles (particles constituted by granulated particles and the conductive polymer) are integrated together can be constructed in the resulting active material containing layer. Therefore, in this case, an electrode which can fully advance an electrode reaction even in a relatively low operating temperature region, has an excellent polarization characteristic, and functions as a polymer electrode can be obtained more easily and more reliably.

In the case of the above-mentioned method, the conductive polymer may be a UV-curable resin or a thermosetting resin, and a conductive polymer advancing a polymerization reaction of the monomer to become a constituent material of the liquid film may be generated in the step of solidifying the liquid film. The polymerization reaction of the monomer to become a constituent material of the UV-curable resin or thermosetting resin can be advanced by irradiation with UV rays or by heating, whereby the monomer can be cured easily in the manufacturing process.

In still another aspect, the present invention provides a method of manufacturing an electrochemical device comprising, at least, an anode, a cathode, and an ionically conductive electrolyte layer, the anode and cathode being arranged so as to oppose each other by way of the electrolyte layer; wherein the electrode manufactured by the above-mentioned method of manufacturing an electrode is used as at least one of the anode and cathode.

This manufacturing method uses the electrode obtained by the above-mentioned method of manufacturing an electrode as at least one of, preferably each of the anode and cathode, and thus can easily and reliably construct an electrochemical device which can fully operate in a relatively low operating temperature region of 40° C. or lower such as room temperature.

### BRIEF DESCRIPTION OF THE DRAWINGS

FIG. 1 is a schematic sectional view showing a basic configuration of a preferred embodiment (lithium-ion secondary battery) of the electrochemical device in accordance with the present invention;

FIG. 2 is an explanatory view showing an example of the granulating step when manufacturing a coating liquid for forming an electrode;

FIG. 3 is an explanatory view showing an example of the step of preparing a coating liquid for forming an electrode by using granulated particles;

FIG. 4 is an explanatory view showing an example of the step of forming an active material containing layer from a liquid film of the coating liquid for forming an electrode;

FIG. 5 is a schematic sectional view showing a basic configuration of another embodiment of the electrochemical device in accordance with the present invention;

FIG. 6 is a schematic sectional view showing a basic configuration of still another embodiment of the electrochemical device in accordance with the present invention;

FIG. 7 is a graph showing a charging/discharging characteristic curve of a measurement cell in Example 1 obtained at an operating temperature of 60° C.; and

FIG. 8 is a graph showing a charging/discharging characteristic curve of a measurement cell in Example 1 obtained when the operating temperature is at room temperature (25° C.).

### BEST MODES FOR CARRYING OUT THE INVENTION

In the following, preferred embodiments of the present invention will be explained in detail with reference to the drawings. In the following explanation, parts identical or equivalent to each other will be referred to with numerals identical to each other without repeating their overlapping descriptions.

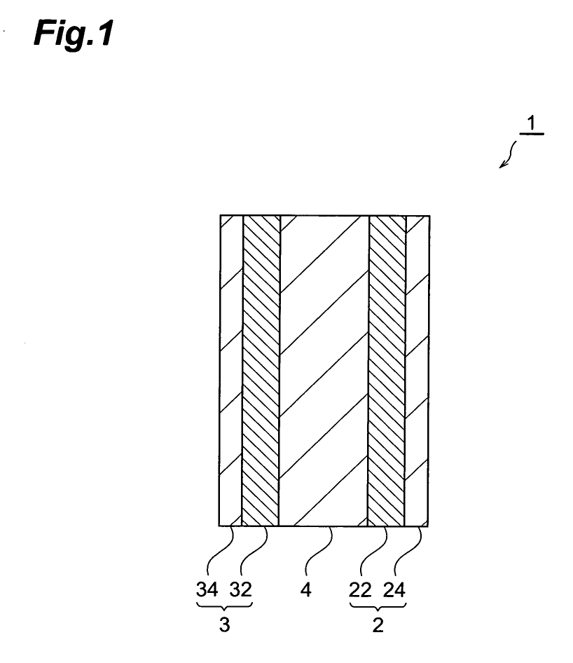

FIG. 1 is a schematic sectional view showing a basic configuration of a preferred embodiment (lithium-ion secondary battery) of the electrochemical device in accordance with the present invention. As shown in FIG. 1, a secondary battery 1 mainly comprises an anode 2, a cathode 3, and an electrolyte layer 4 disposed between the anode 2 and cathode 3.

The secondary battery 1 shown in FIG. 1 comprises, as the cathode 3, an electrode formed by using a coating liquid for forming an electrode (a preferred embodiment of the coating liquid for forming an electrode in accordance with the present invention) prepared by using constituent materials favorably employed as materials of a cathode in the battery of this type and, as the anode 2, an electrode formed by using a coating liquid for forming an electrode (another embodiment of the coating liquid for forming an electrode in accordance with the present invention) prepared by using constituent materials favorably employed as materials of an anode in the battery of this type. The battery 1 comprises the anode 2 including granulated particles which will be explained later, and the cathode 3 including granulated particles which will be explained later, and thus can also fully operate in a relatively low operating temperature region of 40° C. or lower such as room temperature.

The anode 2 of the secondary battery 1 shown in FIG. 1 is constituted by a film-like collector member 24, and a film-like active material containing layer 22 disposed between the collector member 24 and electrolyte layer 4. For example, a copper foil is used as the collector member 24 of the anode 2. The form of the anode 2 is not restricted in particular, and may be shaped like a thin film as depicted, for example.

At the time charging, the anode 2 is connected to an anode of an external power supply (none of which is depicted), and functions as a cathode.

The active material containing layer 22 of the anode 2 is constituted by granulated particles (not depicted) and a conductive polymer. The granulated particles contain an electrode active material, a conductive auxiliary agent, and a binder (none of which is depicted). The granulated particles may further contain a polymer (not depicted) of a kind identical to or different from that of the above-mentioned conductive polymer when necessary.

The conductive polymer constituting the active material containing layer 22 of the anode 2 is not restricted in particular as long as it has a lithium ion conductivity. Examples of such a conductive polymer include those in which monomers of polymer compounds (polyether-based polymer compounds such as polyethylene oxide and polypropylene oxide, crosslinked polymers of polyether compounds, polyepichlorohydrin, polyphosphazene, polysiloxane, polyvinylpyrrolidone, polyvinylidene carbonate, polyacrylonitrile, etc.) are complexed with lithium salts such as LiClO₄, LiBF₄, LiPF₆, LiAsF₆, LiCl, LiBr, Li(CF₃SO₂)₂N, LiN(C₂F₅SO₂)₂ or alkali metal salts mainly composed of lithium. Examples of polymerization initiators used for complexing include photopolymerization initiators and thermal polymerization initiators suitable for the above-mentioned monomers.

The electrode active material constituting the granulated particles contained in the active material containing layer 22 of the anode 2 is not restricted in particular, whereby known electrode active materials may be used. Examples of such an electrode active material include carbon materials capable of occluding/releasing lithium ions (by intercalation or doping/undoping), such as graphite, carbons which are hard to graphitize, carbons which are easy to graphitize, and carbons fired at a low temperature, metals such as Al, Si, and Sn which are combinable with lithium, amorphous compounds mainly composed of oxides such as SiO₂ and SnO₂, and lithium titanate (Li₃Ti₅O₁₂).

The conductive auxiliary agent constituting the granulated particles contained in the active material containing layer 22 of the anode 2 is not restricted in particular, whereby known electrode active materials may be used. Examples of the conductive auxiliary agent include carbon blacks; carbon materials such as highly crystalline synthetic graphite and natural graphite; fine powders of metals such as copper, nickel, stainless, and iron; mixtures of the carbon materials and fine powders of metals; and conductive oxides such as ITO.

The binder constituting the granulated particles contained in the active material containing layer 22 of the anode 2 is not restricted in particular as long as it can bind particles of the above-mentioned electrode active material and particles of the conductive auxiliary agent to each other. Examples of such a binder include fluorine resins such as polyvinylidene fluoride (PVDF), polytetrafluoroethylene (PTFE), tetrafluoroethylene/hexafluoropropylene copolymer (FEP), tetrafluoroethylene/perfluoroalkylvinylether copolymer (PFA), ethylene/tetrafluoroethylene copolymer (ETFE), polychlorotrifluoroethylene (PCTFE), ethylene/chlorotrifluoroethylene copolymer (ECTFE), and polyvinyl fluoride (PVF). This binder contributes not only to binding the above-mentioned particles of the anode active material and particles of the conductive auxiliary agent to each other, but also to binding the foil (collector member 24) and the granulated particles to each other.

As the binder, not only those mentioned above, but also vinylidene-fluoride-based fluorine rubbers such as vinylidene-fluoride/hexafluoropropylene-based fluorine rubber (VDF/HFP-based fluorine rubber), vinylidene-fluoride/hexafluoropropylene/tetrafluoroethylene-based fluorine rubber (VDF/HFP/TFE-based fluorine rubber), vinylidene-fluoride/pentafluoropropylene-based fluorine rubber (VDF/PFP-based fluorine rubber), vinylidene-fluoride/pentafluoropropylene/tetrafluoroethylene-based fluorine rubber (VDF/PFP/TFE-based fluorine rubber), vinylidene-fluoride/perfluoromethylvinyl-ether/tetrafluoroethylene-based fluorine rubber (VDF/PFMVE/TFE-based fluorine rubber), and vinylidene-fluoride/chlorotrifluoroethylene-based fluorine rubber (VDF/CTFE-based fluorine rubber) may be used, for example.

As the binder, not only those mentioned above, but also polyethylene, polypropylene, polyethylene terephthalate, aromatic polyamide, cellulose, styrene/butadiene rubber, isoprene rubber, butadiene rubber, ethylene/propylene rubber, and the like may be used, for example. Thermoplastic elastomeric polymers such as styrene/butadiene/styrene block copolymer, its hydrogenated products, styrene/ethylene/butadiene/styrene copolymer, styrene/isoprene/styrene block copolymer, and its hydrogenated products may also be used. Syndiotactic 1,2-polybutadiene, ethylene/vinyl acetate copolymer, propylene-α-olefin (with a carbon number of 2 to 12) copolymer, and the like may be used as well. The conductive polymer mentioned above may also be used.

The cathode 3 of the secondary battery 1 shown in FIG. 1 is constituted by a film-like collector member 34, and a film-like active material containing layer 32 disposed between the collector member 34 and electrolyte layer 4. For example, an aluminum foil is used as the collector member 34 of the cathode 3. The form of the cathode 3 is not restricted in particular, and may be shaped like a thin film as depicted, for example.

At the time of charging, the cathode 3 is connected to a cathode of an external power supply (none of which is depicted) and functions as an anode.

The electrode active material constituting the granulated particle contained in the active material containing layer 32 of the cathode 3 is not restricted in particular and may be a known electrode active material. Examples of such an electrode active material include lithium cobaltate (LiCoO₂), lithium nickelate (LiNiO₂), lithium manganese spine (LiMn₂O₄), mixed metal oxides represented by the general formula of LiNiₓMn_{y}Co_{z}O₂ (x+y+z=1), lithium vanadium compounds, V₂O₅, olivine-type LiMPO₄ (where M is Co, Ni, Mn, or Fe), and lithium titanate (Li₃Ti₅O₁₂).

As the constituents other than the electrode active material constituting the granulated particles contained in the active material containing layer 32 of the cathode 3, i.e., the conductive auxiliary agent and binder, materials similar to the conductive auxiliary agent and binder constituting the granulated particles contained in the anode 2 can be used. The binder constituting the granulated particles contained in the cathode 3 contributes not only to binding the above-mentioned particles of the anode active material and particles of the conductive auxiliary agent to each other, but also to binding the foil (collector member 34) and the granulated particles to each other.

From the viewpoint of forming contact interfaces of the conductive auxiliary agent, electrode active material, and solid polymer electrolyte three-dimensionally with a sufficient size, the BET specific surface area of the particles of the electrode active material contained in the cathode 3 is preferably 0.1 to 1.0 m²/g, more preferably 0.1 to 0.6 m²/g. The BET specific surface area of the particles of the electrode active material contained in the anode 2 is preferably 0.1 to 10 m²/g, more preferably 0.1 to 5 m²/g. When the electrode of the present invention is not the lithium-ion secondary battery 1 but an electric double layer capacitor, it will be preferred if the BET specific surface area is 500 to 3000 m²/g in each of the cathode 3 and anode 2.

From the same viewpoint as that mentioned above, the average particle size of the particles of the electrode active material in the cathode 3 is preferably 5 to 20 μm, more preferably 5 to 15 μm. The average particle size of the particles of the electrode active material in the anode 2 is preferably 1 to 50 μm, more preferably 1 to 30 μm. Further, from the same viewpoint, the amount of the conductive auxiliary agent and binder attached to the electrode active material is 1 to 30 mass %, more preferably 3 to 15 mass %, when expressed as the value of 100×(the mass of conductive auxiliary agent+the mass of binder)/(the mass of electrode active material).

From the viewpoint of forming contact interfaces between the conductive auxiliary agent, electrode active material, and solid polymer electrolyte three-dimensionally with a sufficient size, the average particle size of the granulated particles obtained by way of a granulating step which will be explained later is preferably 5 to 500 μm, more preferably 5 to 200 μm. The granulated particle obtained by way of the granulating step may be a secondary particle containing a plurality of electrode active materials.

The electrolyte layer 4 may be a layer made of a solid electrolyte as well. The solid electrolyte is constituted by a ceramic solid electrolyte or a solid polymer electrolyte.

An example of the solid polymer electrolyte is a conductive polymer having an ionic conductivity usable in the anode 2 or cathode 3.

Examples of support salts constituting the above-mentioned solid polymer electrolyte include salts such as LiClO₄, LiPF₆, LiBF₄, LiAsF₆, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and their mixtures.

When the secondary battery 1 further comprises a separator, examples of its constituent materials include at least one species of polyolefins such as polyethylene and polypropylene (e.g., two or more layers of bonded films when there are two or more species), polyesters such as polyethylene terephthalate, thermoplastic fluorine resins such as ethylene/tetrafluoroethylene copolymer, and celluloses. When the separator is shaped like a sheet, modes of the sheet include microporous films, woven fabrics, nonwoven fabrics, and the like having an air permeance of about 5 to 2000 seconds/100 cc as measured by the method defined in JIS-P8117 and a thickness of about 5 to 100 μm. Monomers of the solid electrolyte may be used while infiltrating into the separator and being cured therein.

A preferred embodiment of the method of manufacturing a coating liquid for forming an electrode in accordance with the present invention will now be explained.

As mentioned above, the coating liquid for forming an electrode includes granulated particles and a liquid adapted to disperse or dissolve the granulated particles. The granulated particles contain an electrode active material, a conductive auxiliary agent, and a binder. The granulated particles have the same configuration as with the granulated particles mentioned above. Therefore, the electrode active material, conductive auxiliary agent, and solvent are configured as with those mentioned above.

First, the granulating step of making the above-mentioned granulating particles will be explained.

The granulated particles are formed by way of the steps of preparing a material liquid containing a binder, a conductive auxiliary agent, and a solvent; and applying the material liquid to particles made of the electrode active material and then drying the applied liquid, so as to remove the solvent from the material liquid attached to surfaces of the particles made of the electrode active material and bring the particles made of the electrode active material and particles made of the conductive auxiliary agent into close contact with each other by way of the binder.

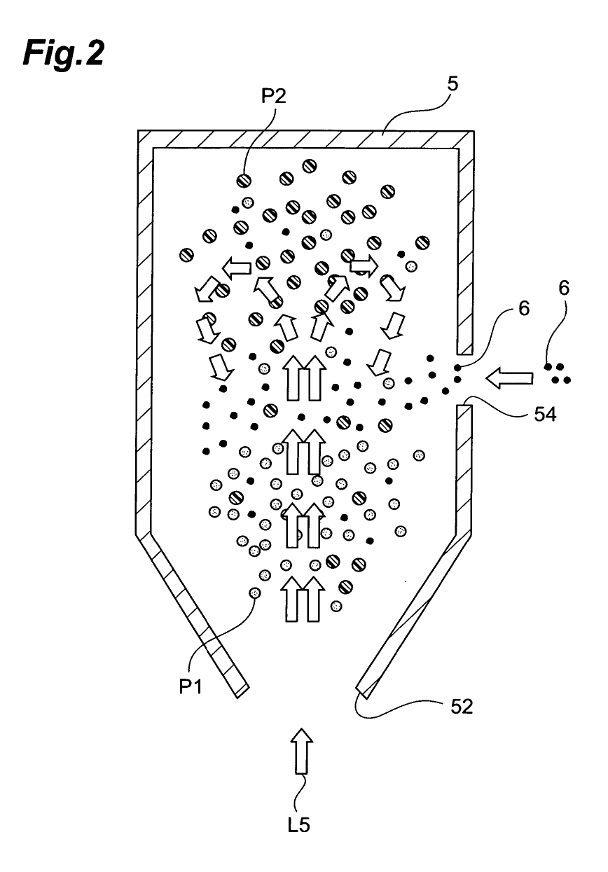

The granulating step will be explained more specifically with reference to FIG. 2. FIG. 2 is an explanatory view showing an example of the granulating step in the case of manufacturing a coating liquid for forming an electrode. First, the binder is dissolved in a solvent adapted to dissolve the binder. The solvent adapted to dissolve the binder is not limited in particular as long as it can dissolve the binder and disperse the conductive auxiliary agent. For example, N-methyl-2-pyrrolidone, N,N-dimethyl formamide, or the like can be used.

Subsequently, the conductive auxiliary agent is dispersed in thus obtained solution, so as to yield a material liquid.

Next, as shown in FIG. 2, particles made of the electrode active material are caused to flow within a fluidizing tank 5, whereas droplets 6 of the material liquid obtained as mentioned above are sprayed, so as to attach the material liquid to particles P1 made of the electrode active material, and the material liquid is dried within the fluidizing tank 5 at the same time. Thus, the solvent is removed from the droplets 6 of the material attached to surfaces of the particles P1 made of the electrode active material, so that the particles made of the electrode active material and the particles made of the conductive auxiliary agent are brought into close contact with each other by way of the binder. In other words, the particles made of the electrode active material are covered and integrated with the conductive auxiliary agent and binder. Granulated particles P2 are obtained as such.

More specifically, for example, the fluidizing tank 5 is a container having a cylindrical form, whose bottom part is provided with an opening 52 for introducing a warm air (or hot air) L5 from the outside and convecting particles of the electrode active material within the fluidizing tank 5 as shown in FIG. 2. The side face of the fluidizing tank 5 is provided with an opening 54 for introducing the sprayed droplets 6 of the material liquid to the particles P1 of the electrode active material convected within the fluidizing tank 5. When manufacturing the granulated particles P2, a warm air (or hot air) is introduced through the fluidizing tank 52, so as to fluidize the particles P1 made of the electrode active material. Then, the droplets 6 of the material liquid are caused to flow into the fluidizing tank 5 through the opening 54, whereby the droplets 6 of the material liquid containing the binder, conductive auxiliary agent, and solvent are sprayed to the particles P1 of the electrode active material convected within the fluidizing tank 5.

Here, for example, the temperature of the warm air (or hot air) is regulated, so that the atmosphere in which the particles P1 of the electrode active material are placed is kept at a predetermined temperature (e.g., a temperature on the order of 50° to 100° C.) at which the solvent in the droplets 6 of the material liquid can be removed rapidly, whereby the liquid film of the material liquid formed on the surfaces of the particles P1 of the electrode active material is dried simultaneously with the spraying with the droplets 6 of the material liquid. This brings the binder and conductive auxiliary agent into close contact with the surfaces of particles of the electrode active material, thereby yielding the granulated particles P2.

An example of the step of adding the granulated particles obtained by the above-mentioned granulating step to a liquid adapted to disperse or dissolve the granulated particles, i.e., the method of preparing a coating liquid for forming an electrode, will now be explained.

The coating liquid for forming an electrode can be obtained by making a mixed liquid in which the produced granulated particles P2, a liquid adapted to disperse or dissolve the granulated particles P2, and a conductive polymer added when necessary are mixed; removing a part of the liquid from the mixed liquid; and adjusting the mixed liquid so as to make it attain a viscosity suitable for coating.

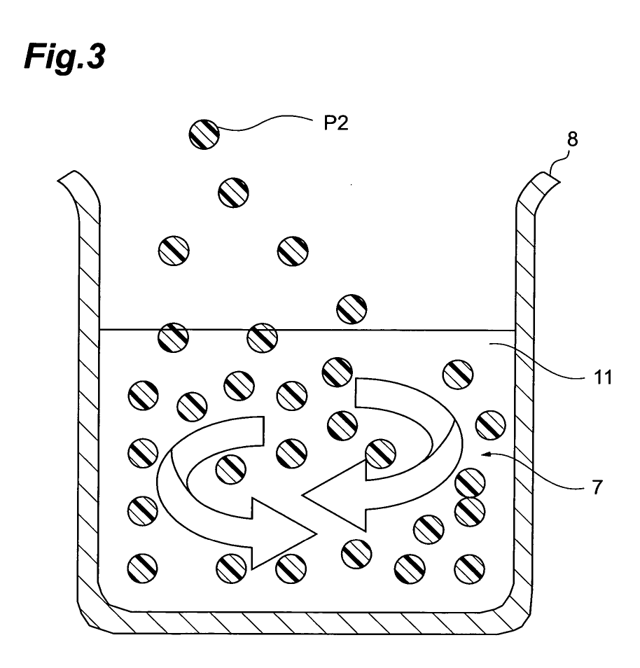

More specifically, when the conductive polymer is used, a mixed liquid in which a liquid 11 adapted to disperse or dissolve the granulated particles P2 and the conductive polymer or a monomer to become a constituent material of the conductor polymer are mixed is prepared in a container 8 equipped with predetermined stirring means such as stirrers (not depicted), for example, as shown in FIG. 3. Subsequently, the granulated particles P2 are added to the mixed liquid, and they are fully stirred, whereby a coating liquid 7 for forming an electrode containing the liquid 11 and the granulated particles P2 dispersed or dissolved in the liquid 11 can be prepared.

A preferred embodiment of the method of manufacturing an electrode in accordance with the present invention will now be explained.

First, the coating liquid for forming an electrode is applied to a surface of a collector member, so as to form a liquid film of the coating liquid on the surface. Employed here as the coating liquid for forming an electrode is one obtained by the above-mentioned method of manufacturing a coating liquid for forming an electrode.

Subsequently, the liquid film is dried, so as to form an active material containing layer on the collector member, thereby completing the making of the electrode.

When the electrode is formed as mentioned above, the conductive auxiliary agent and binder having a relatively small specific gravity are fully prevented from floating up to the vicinity of a surface of the active material containing layer at the time of applying the coating liquid for forming an electrode to the collector member and drying it. Therefore, the state of dispersion of the electrode active material, conductive auxiliary agent, and binder can be made favorable in the active material containing layer. This can also fully prevent the adhesion between the conductive auxiliary agent, electrode active material, and binder from lowering, and the adhesion of the conductive auxiliary agent, electrode active material, and binder to the surface of the collector member from decreasing. Hence, thus obtained electrode can sufficiently advance electrode reactions even in a relatively low operating temperature region of 40° C. or lower such as room temperature, thereby yielding an excellent polarization characteristic.

The technique of applying the coating liquid for forming an electrode to the surface of the collector member is not restricted in particular, and may be determined as appropriate depending on the material and form of the collector, etc. Examples of such a technique include metal mask printing, electrostatic coating, dip coating, spray coating, roll coating, doctor blading, gravure coating, and screen printing.

The technique of forming the active material containing layer from the liquid film of the coating liquid for forming an electrode is not limited to the drying, but may be a technique accompanying a curing reaction among constituents in the liquid film (e.g., a polymerization reaction of a monomer to become a constituent material of the conductive polymer) at the time of forming the active material containing layer from the liquid film of the coating liquid (see Example 1 which will be explained later).

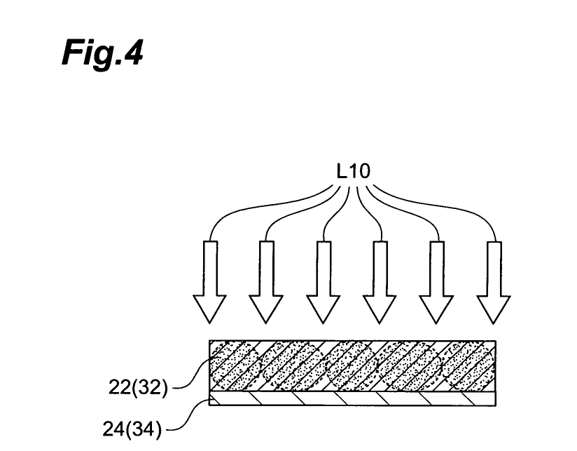

The above-mentioned method of manufacturing an electrode will be explained more specifically with reference to FIG. 4. Here, a method of manufacturing the above-mentioned anode 2 and cathode 3 will be explained.

When a coating liquid for forming an electrode containing a monomer to become a constituent material of a UV-curable resin (conductive polymer) is used, for example, the coating liquid for forming an electrode is initially applied onto the collector member 24 (or collector member 34) by the predetermined method mentioned above.

Next, the coating liquid is dried, and the liquid film of the coating liquid is irradiated with UV rays L10, whereby the active material containing layer 22 (or active material containing layer 32) is formed as shown in FIG. 4. The anode 2 (or cathode 3) is thus obtained.

Since the electrode active material, conductive auxiliary agent, and binder are contained in the granulated particles in this case, the conductive auxiliary agent and binder having a relatively small specific gravity are fully prevented from floating up to the vicinity of surfaces of the active material containing layers 22, 32 at the time of drying the coating liquid. Therefore, the dispersion state of the electrode active material, conductive auxiliary agent, and binder can be made favorable in the active material containing layer 22 (or active material containing layer 32). This can also fully prevent the adhesion between the conductive auxiliary agent, electrode active material, and binder from lowering, and the adhesion of the conductive auxiliary agent, electrode active material, and binder to the surface of the collector member 24 (or collector member 34) from decreasing. Hence, thus obtained anode 2 (or cathode) can sufficiently advance electrode reactions in a relatively low operating temperature region of 40° C. or lower such as room temperature, thereby yielding an excellent polarization characteristic.

After forming the liquid film of the coating liquid for forming an electrode on the collector member 24 (or collector member 34), the monomer is polymerized in the liquid film, so as to generate a conductive polymer. This can generate the conductive polymer in gaps among the granulated particles while substantially keeping the favorable dispersion state of the granulated particles in the liquid film. Therefore, the state of dispersion of the granulated particles and conductive polymer in the resulting active material containing layer 22 (active material containing layer 32) can be made better as compared with a method in which a conductive polymer (a particle made of the conductive polymer) is contained beforehand in a coating liquid for forming an electrode, a liquid film is formed on the collector member 24 (or collector member 34), and then the liquid film is solidified.

Namely, ion conduction networks and electron conduction networks in which finer and denser particles (particles constituted by granulated particles and the conductive polymer) are integrated together can be constructed in the resulting active material containing layer. Therefore, in this case, an electrode which can fully advance an electrode reaction even in a relatively low operating temperature region, has an excellent polarization characteristic, and functions as a polymer electrode can be obtained more easily and more reliably.

In this case, the polymerization reaction of the monomer to become a constituent material of the UV-curable resin can be advanced by irradiation with UV rays.

When necessary, thus obtained active material containing layer may be heat-treated using heat plate pressing and heated rolls and subjected to extending for forming a sheet, etc. In this case, it will be sufficient if the electrode is formed by bonding the active material containing layer and collector member obtained by the extending to each other with a conductive adhesive. The amount of electrode active material supported by the electrode per unit area is preferably 20 to 300 mg/cm², more preferably 25 to 300 mg/cm².

A preferred embodiment of the method of manufacturing an electrochemical device in accordance with the present invention will now be explained. This embodiment relates to a case where the electrochemical device is the above-mentioned lithium-ion secondary battery 1.

First, an anode 2, a cathode 3, and an ionically conductive electrolyte layer 4 are prepared.

As the anode 2 and cathode 3, those manufactured by the above-mentioned method of manufacturing an electrode using a coating liquid for forming an electrode are used. As the coating liquid for forming an electrode, one manufactured by the above-mentioned method of manufacturing a coating liquid for forming an electrode is used.

Subsequently, the electrolyte layer 4 is disposed between the anode 2 and cathode 3, and the anode 2, cathode 3, and electrolyte layer 4 are integrated together, so as to yield a lithium-ion secondary battery 1. An example of the method of integrating the anode 2, cathode 3, and electrolyte layer 4 together is thermocompression bonding.

Manufacturing the lithium-ion secondary battery as such is advantageous as follows.

The above-mentioned manufacturing method prepares a coating liquid for forming an anode and a coating liquid for forming a cathode each containing granulated particles P2 formed by integrating an electrode active material, a conductive auxiliary agent, and a binder together; applies these coating liquids to collector members 22 and 32, respectively; and dries them, so as to yield the anode 2 and cathode 3. Therefore, at the time of drying the coating liquid for forming an anode and the coating liquid for forming a cathode, the conductive auxiliary agent and binder having a relatively small specific gravity are fully prevented from floating up to the vicinity of the surfaces of the active material containing layers 22, 32. Consequently, the state of dispersion of the electrode active material, conductive auxiliary agent, and binder can be made favorable in the active material containing layers 22, 32. This can also fully prevent the adhesion between the conductive auxiliary agent, electrode active material, and binder from lowering, and the adhesion of the conductive auxiliary agent, electrode active material, and binder to the surfaces of the collector members 24, 34 from decreasing. Therefore, thus obtained anode 2 and cathode 3 can sufficiently advance electrode reactions in a relatively low operating temperature region of 40° C. or lower such as room temperature, thereby yielding an excellent polarization characteristic. Hence, thus obtained lithium-ion secondary battery 1 can also fully operate even in a relatively low operating temperature region of 40° C. or lower such as room temperature.

Though preferred embodiments of the present invention are explained in the foregoing, the present invention is not limited thereto.

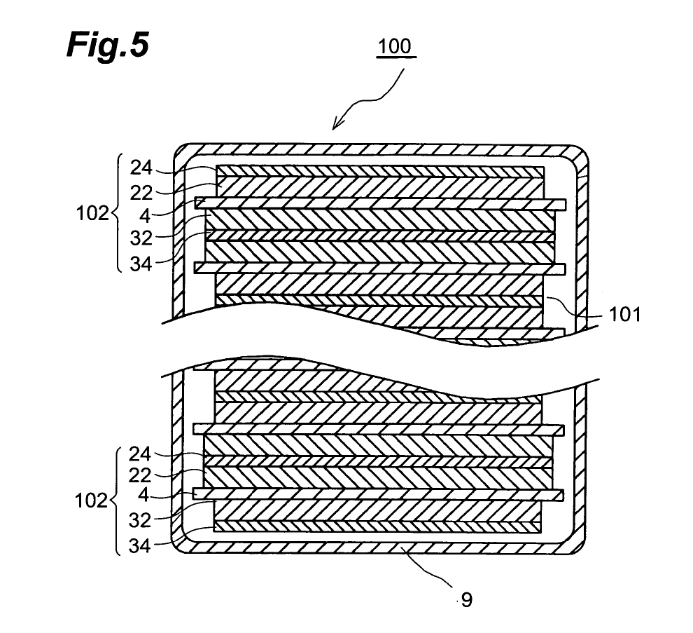

For example, it will be sufficient for the electrode in accordance with the present invention if the active material containing layer includes the granulated particle contained in the coating liquid for forming an electrode in accordance with the present invention, without being restricted in terms of the other structures. It is sufficient for the electrochemical device in accordance with the present invention to comprise the electrode in accordance with the present invention as at least one of the anode and cathode, without being restricted in terms of the other configurations and structures. When the electrochemical device is a battery, for example, the battery may be configured as a module 100 in which a plurality of unit cells (each comprising an anode 2, a cathode 3, and an electrolyte layer 4 also acting as a separator) 102 are laminated and held (packaged) in a state sealed within a predetermined case 9 as shown in FIG. 5.

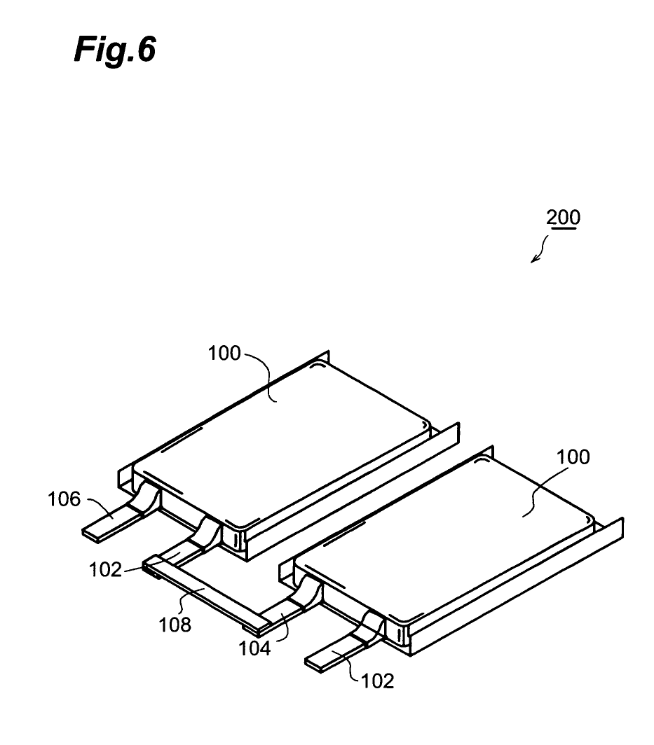

In this case, the unit cells may be connected either in parallel or in series. The electrochemical device in accordance with the present invention may also be a battery unit in which a plurality of modules 100 are connected in series or in parallel, for example. As shown in FIG. 6, for example, a cathode terminal 104 of one module 100 may be electrically connected to an anode terminal 106 of another module 100 by a metal strip 108, so as to construct a serially connected battery unit 200.

When the electrochemical device in accordance with the present invention constitutes the above-mentioned module 100 or battery unit 200, the module 100 or battery unit 200 may further comprise a protection circuit (not depicted) or PTC (not depicted) similar to those provided in known batteries if necessary.

Though the above-mentioned embodiment of the electrochemical device relates to one configured as a secondary battery, it is sufficient for the electrochemical device in accordance with the present invention to comprise, at least, an anode, a cathode, and an ionically conductive electrolyte layer, the anode and cathode being arranged so as to oppose each other by way of the electrolyte layer. The electrochemical device may be a primary battery, for example. In this case, as the electrode active material of the granulated particles, not only the materials exemplified in the above, but also those used in known primary batteries can be used. The conductive auxiliary agent and binder may be the same as the materials exemplified in the above.

The electrode in accordance with the present invention is not limited to electrodes for batteries, but may be those used in electrolytic cells, capacitors (electric double layer capacitors, aluminum electrolytic condensers, etc.), and electrochemical sensors, for example. The electrochemical device in accordance with the present invention is not limited to a battery, but may be an electrolytic cell, a capacitor (electric double layer capacitor, aluminum electrolytic capacitor, etc.), or an electrochemical sensor, for example. In the case of an electric double layer capacitor electrode, for example, carbon materials having a large electric double layer capacity such as coconut shell activated carbon, pitch-based activated carbon, and phenol-resin-based activated carbon may be used as an electrode active material constituting the granulated particles.

Using pyrolyzed ruthenium oxide (or mixed oxide of ruthenium oxide and another metal oxide) as an electrode active material in a constituent material of granulated particles in the present invention, for example, an electrode in which an active material containing layer including thus obtained granulated particles is formed on a titanium support may be constructed as an anode used for brine electrolysis.

When the secondary battery 1 is a metal lithium secondary battery, its anode (not depicted) may be an electrode solely made of metal lithium or a lithium alloy also acting as a collector member. The lithium alloy is not restricted in particular, whereas its examples include Li—Al, LiSi, and LiSn.

In the following, details of the present invention will be explained more specifically with reference to an example and a comparative example, which do not restrict the present invention at all.

### EXAMPLE 1

In the following procedure, a metal lithium secondary battery having the same configuration as that of the metal lithium secondary battery 1 shown in FIG. 1 except that the anode 2 was constituted by a metal lithium foil was made.

(1) Making of Granulated Particles

First, in the following procedure, granulated particles to be contained in an active material containing layer of a cathode (polymer electrode) were made by a granulating step as follows. The granulated particles were constituted by a cathode electrode active material (90 mass %), a conductive auxiliary agent (6 mass %), and a binder (4 mass %). Among mixed metal oxides represented by the general formula of LiₓMn_{y}Ni_{z}Co_{1-x-y}O_{w}, particles (having a BET specific surface area of 0.55 m²/g and an average particle size of 12 μm) of a mixed metal oxide satisfying the condition where x=1, y=0.33, z=0.33, and w=2 were used as the cathode electrode active material. Acetylene black was used as the conductive auxiliary agent. Polyvinylidene fluoride was used as the binder.

First, a liquid (material liquid) in which acetylene black was dispersed in a solution having dissolved polyvinylidene fluoride in N,N-dimethyl formamide (solvent) was prepared. Subsequently, this material liquid (containing 3 mass % of acetylene black and 2 mass % of polyvinylidene fluoride) was sprayed to a powder of the mixed metal oxide fluidized within a container, so as to attach the material liquid to the surface of the powder. The temperature in the atmosphere in which the powder was placed at the time of spraying was held constant, so that N,N-dimethyl formamide was eliminated from the powder surface substantially simultaneously with the spraying. Acetylene black and polyvinylidene fluoride were thus brought into close contact with the powder surface, so as to yield granulated particles (having an average particle size of 150 μm). The respective amounts of the cathode electrode active material, conductive auxiliary agent, and binder used in this granulating process were regulated such that the mass ratios of these ingredients in the finally obtained granulated particles became the values mentioned above.

(2) Preparation of Coating Liquid for Forming Electrode

First, a conductive polymer to become a constituent material of a cathode (polymer electrode) together with the above-mentioned granulated particles was synthesized under the following condition. To begin with, LiN(C₂F₅SO₂)₂ (manufactured by 3M under the product name of “LiBETI”) and a terminal-acryloyl-denatured alkylene oxide macromonomer (manufactured by Dai-Ichi Kogyo Seiyaku Co., Ltd. under the product name of “Elecell”, which will hereinafter be referred to as “macromonomer”) were put into acetonitrile and mixed therewith, whereby a mixture containing LiN(C₂F₅SO₂)₂ and macromonomer was prepared. Here, the mixing ratio of LiN(C₂F₅SO₂)₂ and macromonomer was adjusted so as to become 1:10 in terms of the molar ratio of Li atoms constituting LiN(C₂F₅SO₂)₂ to O (oxygen) atoms in the macromonomer.

Subsequently, a photopolymerization initiator (benzophenone-based photopolymerization initiator) was further mixed into the mixed liquid. The amount of photopolymerization initiator introduced in this step was adjusted such that the mass of photopolymerization initiator:the mass of macromonomer=1:100.

Next, using an evaporator, acetonitrile was eliminated from the mixed liquid obtained after the above-mentioned step, whereby a liquid having an enhanced viscosity (which will hereinafter be referred to as “Li salt macromonomer solution”) was obtained. Then, the Li salt macromonomer solution and the granulated particles mentioned above were mixed together and kneaded, whereby the preparation of the coating liquid for forming an electrode for a cathode was completed. In this step, the amounts of Li salt macromonomer solution and granulated particles in use were adjusted such that the mass of granulated particles:the mass of Li salt macromonomer solution=4:1.

(3) Making of Cathode

Next, using the above-mentioned coating liquid for forming an electrode, a cathode (polymer electrode) was made by the following procedure. First, the coating liquid for forming an electrode was applied to one surface of an aluminum collector member [aluminum foil (having a film thickness of about 25 to 30 μm and a circular form with a diameter of 15 mm)], so as to form a liquid film of the coating liquid for forming an electrode on this surface. Subsequently, the liquid film was irradiated with UV rays, so as to advance a polymerization reaction of the macromonomer contained in the liquid film, thereby generating a conductive polymer (polyalkylene-oxide-based solid polymer electrolyte). Here, the curing of the liquid film progressed as the conductive polymer was generated upon the irradiation with UV rays, whereby the active material containing layer in the cathode was obtained.

Further, thus obtained film-electrode composite constituted by the collector member and active material containing layer was pressed by hot-pressing under the temperature condition of 100° C. and pressing condition of 15 kN/cm², so as to enhance the adhesion between the collector member and active material containing layer, and increase the density and adhesion of each constituent in the active material containing layer, thereby completing a cathode (having a circular electrode area with a diameter of 15 mm and an active material containing layer thickness of 150 μm).

(4) Making of Electrolyte Layer

Next, in the following manner, a solid polymer electrolyte film to become an electrolyte layer was made. First, in the same procedure as that used in the preparation of the above-mentioned coating liquid for forming an electrode, an Li salt macromonomer solution was prepared. Subsequently, two PET films were set on a coater in a state where the films opposed each other with a gap of 35 μm [in a state where the normal direction of the faces (opposing faces) of films opposing each other was parallel to the falling direction of droplets of the coating liquid for forming an electrode which will be dropped in a step which will be explained later].

The coating liquid for forming an electrode was dropped from above the coater onto the opposing surface of the lower film in the two PET films set to the coater. Subsequently, the upper PET film was caused to hold the dropped coating liquid thereunder, whereby a uniform liquid film made of the coating liquid for forming an electrode was formed between the two PET films. Then, the liquid film was irradiated with UV rays, so as to advance the polymerization reaction of the macromonomer contained in the liquid film and proceed with its curing, thereby yielding a solid polymer electrolyte film (a polyalkylene-oxide-based solid polymer electrolyte film having a thickness of 35 μm).

(5) Making of Measurement Cell for Battery Characteristic Evaluation Test

As an anode, a metal lithium foil (having a film thickness of 200 μm and a circular electrode area with a diameter of 16 mm) was prepared. Subsequently, the above-mentioned solid polymer electrolyte film was disposed between the anode and cathode (such that the active material containing layer side of the cathode faced the solid polymer electrolyte film), and the active material containing layers of the anode and cathode were brought into contact with the solid polymer electrolyte film, thereby constructing a film-electrode composite. Then, an aluminum plate and a copper plate which have respective areas greater than their corresponding areas of the cathode and anode were prepared, the film-electrode composite was disposed between the two plates, and the inner faces of the two plates were brought into contact with the film-electrode composite, whereby a measurement cell (metal lithium secondary battery) for a battery characteristic evaluation test which will be explained later was constructed. The aluminum plate and copper plate were disposed in contact with the cathode and anode, respectively.

### COMPARATIVE EXAMPLE 1

First, as the electrode active material, conductive agent, and binder, those used in Example 1 were employed and were mixed such that the mass of electrode active material:the mass of conductive agent:the mass of binder=90:6:4, whereby a powdery mixture was obtained. Subsequently, an Li salt macromonomer solution was prepared in the same procedure under the same condition as with Example 1. Then, the above-mentioned mixture and the Li salt macromonomer solution were mixed and kneaded, so as to prepare a coating liquid for forming an electrode for a cathode. In this step, the amounts of Li salt macromonomer solution and mixture in use were adjusted such that the mass of mixture:the mass of Li salt macromonomer solution=4:1.

Next, the coating liquid for forming an electrode was applied to one surface of the same aluminum collector member as that used in Example 1, so as to form a liquid film of the coating liquid for forming an electrode on this surface. Subsequently, in the same procedure under the same condition as with Example 1, the liquid film was irradiated with UV rays and then was pressed by hot pressing, whereby a cathode (having a circular electrode area with a diameter of 16 mm and an active material containing layer thickness of 150 μm) was completed. Thereafter, in the same procedure under the same condition as with Example 1 except that the above-mentioned cathode was employed, a film-electrode composite and a measurement cell equipped therewith were made.

Battery Characteristic Evaluation Test

For each of the measurement cells of Examples 1 and Comparative Example 1, respective charging/discharging characteristics were measured when the operating temperature was at room temperature (25° C.) and 60° C. Table 1 shows the results of the test. During the measurement, the plate disposed on the cathode side of the film-electrode composite in the plates in each of the measurement cells was continuously pressed by a predetermined pressure from the outside with pressing means including a spring made of a metal. The pressure applied to each measurement cell at the time of pressing was adjusted such that the electric contact resistance between the electrodes (cathode and anode) and the solid electrolyte film was minimized.

TABLE 1

| | OPERATING TEMPERA- | | OPERATING TEMPERA- | |
|---|---|---|---|---|
| | TURE: 60° C. | | TURE: 25° C. | |
| | | DIS- | | DIS- |
| | CHARGING | CHARGING | CHARGING | CHARGING |
| | CAPACITY | CAPACITY | CAPACITY | CAPACITY |
| EXAMPLE 1 | 100% | 100% | 47% | 47% |
| COMPARA- | 100% | 100% | 1% | 1% |
| TIVE | | | | |
| EXAMPLE 1 | | | | |

As can be seen from the results shown in Table 1, it was verified that the measurement cell of Example 1 had excellent charging/discharging characteristics not only when the operating temperature was 60° C., but also when the operating temperature was lowered to room temperature. On the other hand, the measurement cell of Comparative Example 1 was unable to perform charging/discharging when the operating temperature was lowered to room temperature, though it exhibited a charging/discharging characteristic substantially on a par with that of the measurement cell of Example 1 when the operating temperature was 60° C.

The results obtained from the measurement cells of Example 1 and Comparative Example 1 suggest that, in an electrode formed by using a coating liquid for forming an electrode including granulated particles, contact interfaces between the conductive auxiliary agent, electrode active material, and electrolyte (e.g., a solid polymer electrolyte), which become reaction sites for electron transfer reactions proceeding within the active material containing layer, are three-dimensionally formed with a sufficient size, while the active material containing layer and collector member are in a quite favorable electric contact state, so that this electrode exhibits an excellent electrode characteristic even at room temperature, whereby a battery mounted with this electrode can generate electricity at room temperature, which has conventionally been impossible.

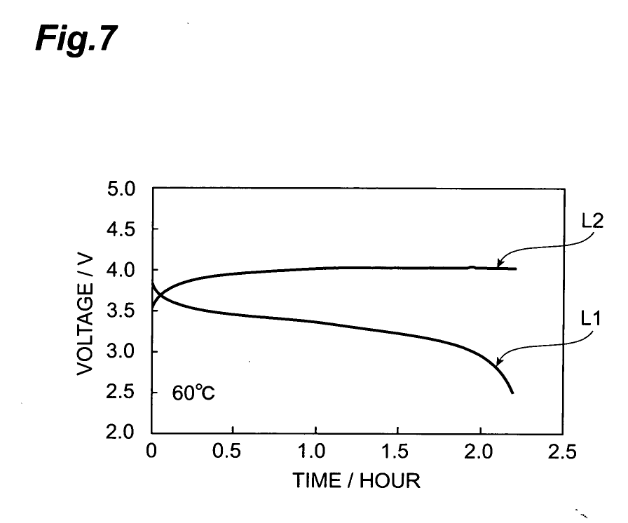

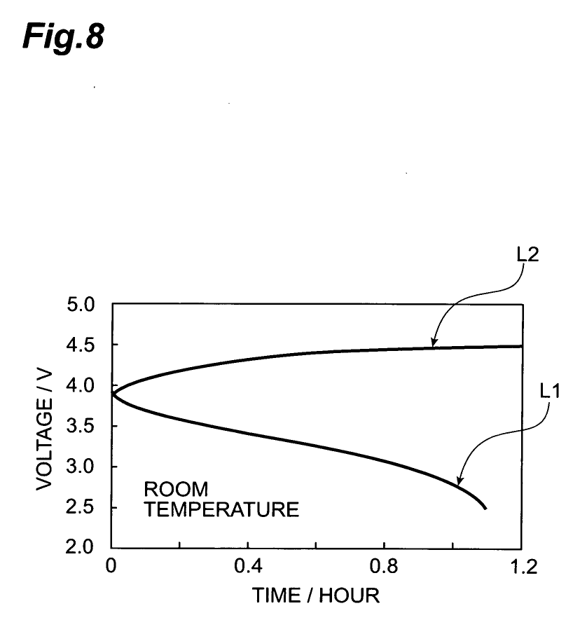

For the measurement cell of Example 1, a graph indicating a charging/discharging characteristic curve at a constant current obtained at an operating temperature of 60° C. was shown in FIG. 7, whereas a graph indicating a charging/discharging characteristic curve at a constant current (at the same value as in FIG. 7) obtained when the operating temperature was room temperature (25° C. here) was shown in FIG. 8.

Industrial Applicability

As explained in the foregoing, the present invention can provide a coating liquid for forming an electrode which can easily and reliably form an electrode having such an excellent polarization characteristic as to be able to advance an electrode reaction even in a relatively low operating temperature region of 40° C. or lower such as room temperature. Also, the present invention can provide an electrode having the excellent polarization characteristic mentioned above. Further, the present invention can provide an electrochemical device which favorably operates even in the above-mentioned relatively low operating temperature region. For example, the present invention can easily and reliably construct an all-solid-state battery such as metal lithium secondary battery which can favorably operate at room temperature as well.

Also, the present invention can provide respective manufacturing methods which can easily and reliably yield the above-mentioned coating liquid for forming an electrode, electrode, and electrochemical device in accordance with the present invention.

1. A coating liquid for forming an electrode, the coating liquid including as constituents:
a granulated particle containing an electrode active material, a conductive auxiliary agent having an electronic conductivity, and a binder capable of binding the electrode active material and conductive auxiliary agent to each other; and
a liquid adapted to disperse or dissolve the granulated particle.

2. A coating liquid for forming an electrode according to claim 1, wherein the granulated particle further contains a conductive polymer.

3. A coating liquid for forming an electrode according to claim 1, further containing, as the constituent, a conductive polymer or a monomer to become a constituent material of the conductive polymer.

4. An electrode comprising at least:
a conductive active material containing layer including, as a constituent material, a granulated particle containing an electrode active material, a conductive auxiliary agent having an electronic conductivity, and a binder capable of binding the electrode active material and conductive auxiliary agent to each other; and
a conductive collector member disposed in electric contact with the active material containing layer.

5. An electrode according to claim 4, wherein the active material containing layer further contains a conductive polymer.

6. An electrode according to claim 4, wherein the granulated particle further contains a conductive polymer.

7. An electrochemical device comprising, at least, an anode, a cathode, and an ionically conductive electrolyte layer, the anode and cathode being arranged so as to oppose each other by way of the electrolyte layer;
wherein at least one of the anode and cathode comprises at least:
a conductive active material containing layer including, as a constituent material, a granulated particle containing an electrode active material, a conductive auxiliary agent having an electronic conductivity, and a binder capable of binding the electrode active material and conductive auxiliary agent to each other; and
a conductive collector member disposed in electric contact with the active material containing layer.

8. An electrochemical device according to claim 7, wherein the active material containing layer further contains a conductive polymer.

9. An electrochemical device according to claim 7, wherein the granulated particle further contains a conductive polymer.

10. An electrochemical device according to claim 7, wherein the electrolyte layer contains a solid electrolyte.

11. An electrochemical device according to claim 10, wherein the solid electrolyte contains a ceramic solid electrolyte or a solid polymer electrolyte.

12. A method of manufacturing a coating liquid for forming an electrode, the method comprising the steps of:
coating and integrating a particle made of an electrode active material with a conductive auxiliary agent and a binder, so as to yield a granulated particle; and
adding the granulated particle to a liquid adapted to disperse or dissolve the granulated particle.

13. A method of manufacturing a coating liquid for forming an electrode according to claim 12, wherein the step of yielding the granulated particle includes the steps of:
preparing a material liquid containing the binder, the conductive auxiliary agent, and a solvent; and
attaching the material liquid to the particle made of the electrode active material, and drying the liquid so as to remove the solvent from the material liquid attached to a surface of the particle made of the electrode active material and bring the particle made of the electrode active material and the particle made of the conductive auxiliary agent into close contact with each other by way of the binder.

14. A method of manufacturing a coating liquid for forming an electrode according to claim 13, wherein, in the step of yielding the granulated particle, the material liquid is attached by spraying to the particle made of the electrode active material.

15. A method of manufacturing a coating liquid for forming an electrode according to claim 13, wherein the solvent contained in the material liquid is adapted to dissolve the binder and disperse the conductive auxiliary agent.

16. A method of manufacturing a coating liquid for forming an electrode according to claim 13, wherein a conductive polymer is further dissolved in the material liquid.

17. A method of manufacturing a coating liquid for forming an electrode according to claim 12, wherein a conductive polymer or a monomer to become a constituent material of the conductive polymer is further dissolved in the liquid.

18. A method of manufacturing an electrode comprising, at least, a conductive active material containing layer including an electrode active material, and a conductive collector member disposed in electric contact with the active material containing layer, the method comprising the steps of:
applying the coating liquid for forming an electrode manufactured by the method of manufacturing a coating liquid for forming an electrode according to claim 12 to a part to be formed with the active material containing layer in the collector member; and
solidifying a liquid film made of the coating liquid for forming an electrode applied to the part to be formed with the active material containing layer in the collector member.

19. A method of manufacturing an electrode according to claim 18, wherein the coating liquid for forming an electrode contains a monomer to become a constituent material of a conductive polymer; and
wherein a polymerization reaction of the monomer is advanced in the step of solidifying the liquid film, so as to generate the conductive polymer.

20. A method of manufacturing an electrode according to claim 19, wherein the conductive polymer is a UV-curable resin; and
wherein a polymerization reaction of the monomer to become a constituent material of the liquid film is advanced in the step of solidifying the liquid film, so as to generate the conductive polymer.

21. A method of manufacturing an electrochemical device comprising, at least, an anode, a cathode, and an ionically conductive electrolyte layer, the anode and cathode being arranged so as to oppose each other by way of the electrolyte layer;
wherein the electrode manufactured by the method of manufacturing an electrode according to claim 18 is used as at least one of the anode and cathode.
